(19) United States
(12) Patent Application Publication
(10) Pub. No.: US 2010/0216586 A1
(43) Pub. Date: Aug. 26, 2010

(54) QUICK-CHANGE TRUCK DRIVE

(75) Inventor: Keith E. Gleasman, Fairport, NY (US)

Correspondence Address: BROWN & MICHAELS, PC;400 M & T BANK BUILDING, 118 NORTH TIOGA ST, ITHACA, NY, 14850, US

(73) Assignee: TORVEC, INC., Rochester, NY (US)

(21) Appl. No.: 12/712,242

(22) Filed: Feb. 25, 2010

Related U.S. Application Data
(60) Provisional application No. 61/155,366, filed on Feb. 25, 2009.

(51) Int. Cl. F16H 37/08; F16H 1/06; B60K 17/36

(52) U.S. Cl. 475/198; 74/414

(57) ABSTRACT

The drive train of a truck is modified by the addition of a single changeable pair of mating gears positioned between the output shaft of the transmission and the intermediate gear train that drives the ring/bull gear fixed to the drive-axle differential for a first set of drive wheels. One gear of this changeable pair is releasably connected to the distal end of the output shaft of the transmission, while the mating gear is releasably connected to the input of the intermediate gear train of the ring/bull gear for single drive-axle trucks or to the housing of a high-bias drive-shaft differential having co-axial output shafts for tandem drive-axle trucks. These changeable gear pairs are preferably maintained in stock in predetermined ratios so that the drive ratio of the truck can be quickly, easily, and inexpensively altered by the selection of an appropriate gear pair to accommodate different expected operating conditions.

### REFERENCE TO RELATED APPLICATIONS

This application claims one or more inventions which were disclosed in Provisional Application No. 61/155,366, filed Feb. 25, 2009, entitled “QUICK-CHANGE TRUCK AXLE”. The benefit under 35 USC §119(e) of the U.S. provisional application is hereby claimed, and the aforementioned application is hereby incorporated herein by reference.

### BACKGROUND OF THE INVENTION

1. Field of the Invention

This invention relates to the drive trains for automotive trucks and, more particularly, to apparatuses for readily altering the drive ratio between the drive wheels and engine of mid-size to large trucks.

2. Description of Related Art

All trucks have a variable transmission that can be adjusted throughout a range of selectable transmission ratios to vary the speed of the drive wheels relative to the speed of the engine in accordance with the conditions under which the truck is operating. The lowest ratio at which the drive wheels can be operated is often referred to as the “drive ratio” of the truck. Persons skilled in the art will appreciate that this drive ratio is a combination of all the gear reductions found in the drive train including the lowest transmission ratio as well as the further gear reductions occurring between pinions and large ring/bull gears driving each differential, etc. While most of these gear reductions occur through gear trains positioned within the vehicle's transmission housing and within the differential complexes, in some specialized vehicles there may be a further reduction between the individual drive axles and their respective wheels.

Most trucks, including mid-size and large trucks, have only a single pair of drive wheels mounted on one set of axles divided by a drive-wheel differential. However, many larger trucks have two sets of drive axles positioned in tandem, and each set of drive axles is divided by a respective drive-wheel differential. Further, since the tandem axles of these large trucks do not rotate at the same speeds when the truck is turning or passing over uneven terrain, a torque-divider (e.g., a cam-and-pawl mechanism) having co-axial output shafts is provided to divide the drive torque from the transmission between the two sets of drive axles. Each of these separate drive axles receives driving torque from its respective torque-divider output through a respective gear train that includes a bevel pinion and ring gear combination followed by a helical gear in mesh with a much larger ring gear. This much larger ring gear is often called a “bull” gear and, to clarify identification is referred to herein as a “ring/bull” gear. The respective gear trains are each mounted in a respective cast iron housing sometimes referred to as a “pig”. Thus, each of the two drive axles has a respective “pig” interconnected by the torque-divider.

Since trucks are operated under widely divergent conditions that can vary from carrying relatively light loads over paved roads at fast highway speeds to extremely heavy loads over rutted and soggy off-road terrain, truck manufacturers often provide different models of trucks for various major categories of expected operations, e.g., light or heavy loads, for highway transport, or construction, or refuse hauling, etc. Also, some multi-use models of trucks can be used for widely disparate operations and are sold with any one of numerous selectable drive trains, e.g., drive ratios varying from 3:8 to 9:1 according to the desired operation. Each of these different drive ratios uses a different combination of gearing in the gear-train of the drive axle pig (or in each pig of a tandem-drive truck). The customer selects a drive ratio appropriate for its needs and, if this ratio is not available on a truck in stock, a different truck is ordered by the dealer.

Therefore, dealers usually try to keep a selection of multi-use models available, each truck having a different drive ratio because, if they do not have a vehicle with the desired drive ratio in stock, they have to make a special order from the manufacturer for a model with the desired drive ratio. Owners of fleets of trucks similarly try to keep a variety of drive ratios in their fleets, particularly since only certain drive ratios are reasonably appropriate for some operations. One prior art solution to this problem is disclosed in U.S. Pat. No. 4,437,530 by providing a changeable set of planetary reduction gears affixed to the output end of the final drive between the transmission and the drive wheels.

In a related problem, well known to those skilled in the art, torque-dividers are used in tandem drive-axle trucks because the use of conventional standard differentials is prevented since standard differentials cannot provide the required co-axial output due to the cross-pin that supports the differential's drive pinions. Unfortunately, these prior art torque-dividers suffer from damaging wear, particularly when there are repeated differences between the speeds of the two sets of heavily loaded tandem axles, causing the torque-dividers to slip and resulting in drive-train “chatter”. While this chatter is particularly noticeable at low speeds, it also occurs at all speeds when terrain differences are encountered, causing the vehicle load to alternate between the two sets of axles and resulting in repetitive shocks and undesirable wear throughout the entire drive train of the vehicle.

As will be explained in greater detail below, a preferred embodiment of the invention for use in tandem drive-axle trucks replaces the conventional torque-divider with a limited-slip crossed-axis compound planetary gear differential to divide the input torque between the tandem axles of large trucks. [Those skilled in the art are reminded that, as different from open differentials and limited-slip designs based upon standard differential gear arrangements, differentials using a crossed-axis compound planetary gear complex can provide co-axial outputs, since they do not include a cross-pin to connect the driver pinions.]

While there are many types of traction-assisting differentials, one of the most commercially successful has been the all-gear differentials based upon the designs of Vernon E. Gleasman. This high-bias differential is based upon his crossed-axis design that has been identified commercially as the Torsen®-Type 1 differential. Recent improvements of this high-bias differential using crossed-axis planetary gearing are disclosed in U.S. Pat. No. 6,783,476 (“Compact Full-Traction Differential”) and U.S. Pat. No. 7,542,821 (“Full Traction Differential with Hybrid Gearing”), both assigned to the same assignee as the present invention and identified by the trademark IsoTorque®, and both of those references are incorporated herein by reference.

[NOTE: To avoid confusion, the following explanation of the invention will identify the differential positioned between the drive wheels of each set of axles as a “drive-axle” differential, while the differential being substituted for the torque-divider between the two tandem axle sets of a large truck will be indentified as a “drive-shaft” differential.]

To supplement the detailed disclosure below, reference is now made to FIG. 1 which illustrates a crossed-axis compound planetary gear differential of the type being used as a drive-shaft differential in preferred embodiments of the invention. As shown in FIG. 1, the differential includes a rotatable gear housing 10 and a pair of drive axles 11, 12 that are received in bores formed in the sides of the housing 10. A flange 13 is formed at one end of the housing 10 for mounting a ring gear (not shown) for providing rotational power from an external power source, e.g., from a vehicle's engine. The gear arrangement within the housing 10 includes (a) a pair of side-gear worms 14, 15 fixed, respectively, to the inner ends of the axles 11, 12 and (b) several sets of combination gears 16 organized in pairs, each combination gear having outer ends formed with integral spur gear portions 17 spaced apart from “worm-wheel” portion 18. [NOTE: While standard gear nomenclature uses the term “worm-gear” to describe the mate to a “worm”, this often becomes confusing when describing the various gearing of an all-gear differential. Therefore, it will be noted that, as used in the prior art incorporated by reference herein, the mate to a side-gear worm is called a “worm-wheel”. Nonetheless, as used in the invention disclosed herein, the side-gear worms and the mating portions of the combination gears of the crossed-axis compound planetary gear differentials may also be more conventional helical gearing.]

Each pair of combination gears 16 is mounted within slots or bores including mounting shafts 19 formed in the main body of the housing 10 so that each combination gear rotates on an axis that is substantially perpendicular to the axis of rotation of the side-gear worms 14, 15. The spur gear portions 17 of the combination gears 16 of each pair are in mesh with each other, while the worm-wheel portions 18 are, respectively, in mesh with one of the side-gear worms 14, 15 for transferring and dividing torque between the axle ends 11, 12. In order to carry most automotive loads, prior art differentials of this type usually include three sets of paired combination gears positioned at approximately 120° intervals about the periphery of each side-gear worm 14, 15.

For purposes of the invention disclosed herein, the type of crossed-axis differential just generally described above incorporates many of the improvements described in the above-identified incorporated references.

An additional drive train problem with today's fleets of trucks is that, because a large portion of current truck axles are over 30 years old, they do not have the proper axle ratio in order to optimize fuel economy when driving on highways.

The invention disclosed below provides a simple and inexpensive solution for the drive train problems referred to above.

### SUMMARY OF THE INVENTION

The drive train of a truck is modified by the addition of a single changeable pair of mating gears at the intersection between the output shaft of the transmission and the differential complex, i.e., at the input of the final drive assembly. More particularly, this changeable gear pair is positioned between the output shaft of the transmission and the intermediate gear train that drives the ring/bull gear fixed to the drive-axle differential for a first set of drive wheels. One gear of this changeable pair is releasably connected to the distal end of the output shaft of the transmission, while the mating gear of the pair is releasably connected to the input of either (a) the intermediate gear train of the ring/bull gear (for single drive-axle trucks) or (b) the drive-shaft differential (for tandem drive-axle trucks). Persons skilled in the art will understand that the input to a differential is generally a flange fixed to one end of the housing for providing rotational power.

This single changeable gear pair has helical or spur teeth and, preferably, the gear connected to the distal end of the transmission output shaft is a ring gear with internal teeth, thereby (a) maintaining the same direction of shaft rotation between the gear pair, and (b) permitting minor shaft alignment adjustments between the transmission and rear axle without requiring the use of universal joints. This changeable gear pair is readily and quickly replaceable. Several sets of these changeable gears are preferably maintained in stock (by the dealer or fleet owner) in predetermined ratios so that the drive ratio of the truck is easily and inexpensively alterable by the selection of an appropriate gear pair to accommodate different expected operating conditions.

In addition to the short time required to make the drive ratio change according to the invention herein, the cost of the parts for making this relatively easy change is limited to only a single pair of mating helical or spur gears to interconnect the vehicle drive axle with either the gear-train of the drive-axle pig (of a single drive-axle truck) or the housing flange of the drive-shaft differential that delivers the divided driving torque to each drive-axle pig of a tandem pair. That is, the gear trains of the relatively large pigs associated with drive axles of the trucks do not have to be moved or altered in any way. Dealers or fleet owners need only maintain a varied supply of quick-change gear pairs to readily provide the customer's desired drive ratio.

Another advantage of a changeable pair of mating gears of the present invention is improved fuel economy for the highway driving of current fleets of trucks. As mentioned above, a large portion of current truck axles are more than 30 years old, and a redesign and building of the whole truck axle, costing millions of dollars, would be required to get the proper axle ratio in order to optimize the fuel economy of current trucks driving at high speeds on today's highways. A changeable pair of mating gears of the present invention is capable of providing the higher axle ratio required to optimize fuel economy of current trucks conveniently and inexpensively without redesigning and replacing the whole truck axle.

Also, one preferred embodiment of the invention herein replaces the prior art torque-divider used to divide driving torque between the respective axles of tandem drive-axle trucks with a full-traction differential having a crossed-axis compound planetary gear complex to avoid chatter problems. Recent improvements in the latter differential have shown minimal wear when tested under significant heavy load conditions.

### BRIEF DESCRIPTION OF THE DRAWINGS

FIG. 1 shows a partially cross-sectioned side view of a prior art crossed-axis compound planetary gear differential.

FIG. 2 shows a schematic block diagram of two prior art versions of truck drive trains.

FIG. 3 shows a schematic perspective view of the differential complex of the first drive axle of a prior art tandem-axle drive, including the torque-divider, the intermediate gear train, and the ring/bull gear fixed to the drive-axle differential.

FIG. 4 shows a schematic view of an apparatus similar to that shown in FIG. 3 from the opposite perspective but modified by the substitution of a crossed-axis compound planetary gear differential in a first embodiment of the present invention.

FIG. 5 shows a schematic perspective view of an apparatus similar to that shown in FIG. 4 for a tandem-axle drive truck modified by the addition of a readily changeable pair of drive-ratio change gears in a second embodiment of the present invention.

FIG. 6 shows a schematic perspective view of a differential complex for a mid-size truck having only a single set of drive wheels and including a readily changeable pair of drive-ratio change gears in a third embodiment of the present invention.

FIG. 7 shows a schematic perspective view of a differential complex for a tandem drive-axle truck including a different form of gearing for the readily changeable pair of drive-ratio change gears in a fourth embodiment of the present invention.

FIG. 8 shows a cross-sectional view of the complex of FIG. 7.

FIG. 9 shows a schematic diagram indicating the range of adjustability for aligning the drive shaft of the vehicle with the input to the differential complex when using the readily changeable pair of drive-ratio change gears shown in FIG. 7.

FIG. 10 shows a differential complex similar to that shown in FIG. 6 for a mid-size truck having only a single set of drive wheels but including a readily changeable pair of drive-ratio change gears in the format of the gearing illustrated in FIG. 7 in a fifth embodiment of the present invention.

### DETAILED DESCRIPTION OF THE INVENTION

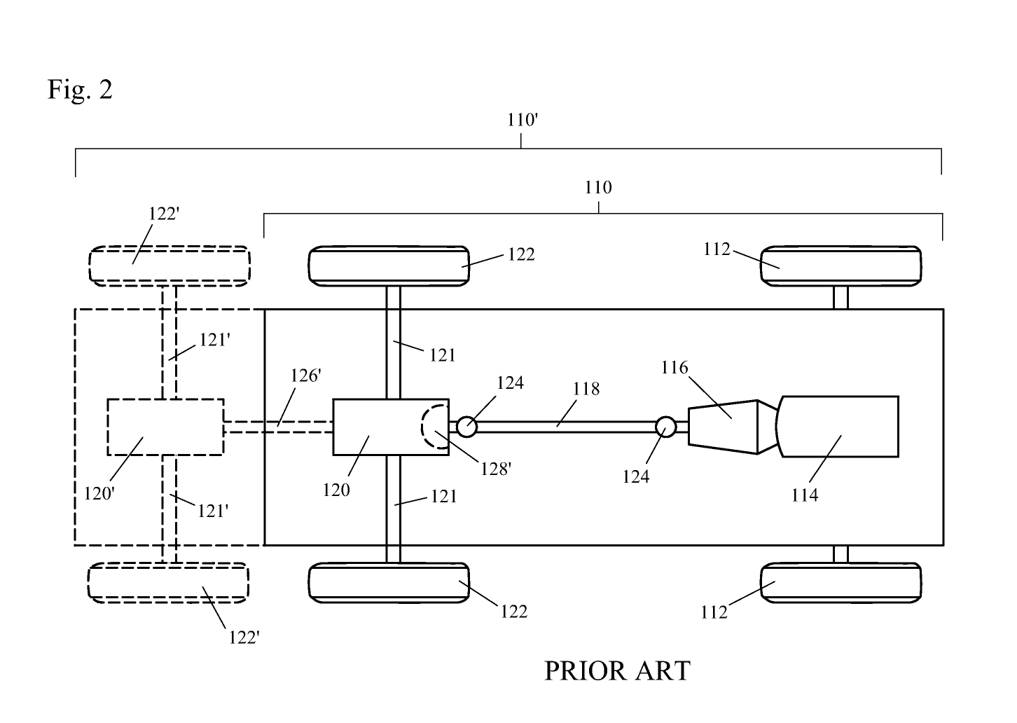

The drive trains of mid-size and large trucks are illustrated schematically in FIG. 2. The mid-size truck 110 has a pair of steered front wheels 112 and an engine 114 and a transmission 116 that turn a drive shaft 118 connected to a differential complex 120 that delivers drive torque to the axles 121 of at least one set of drive wheels 122. Since design requirements often require that the differential complex 120 be slightly misaligned with the transmission 116, the drive shaft 118 usually includes universal couplings 124 as indicated.

A larger truck 110′ (such as the trucks used to pull semitrailers) often includes a second set of drive wheels 122′ positioned in tandem with the first set of drive wheels 122. These drive wheels 122′ are similarly mounted on axles 121′ to which driving torque is delivered through a second differential complex 120′ from a divided-drive shaft 126′. Since the distance between the two sets of tandem drive axles 121, 121′ causes the axles to rotate at different speeds when the truck is turning or passing over uneven terrain, the addition of the second set of axles requires the use of a torque-divider 128′ (indicated in dotted lines) to account for these speed differences.

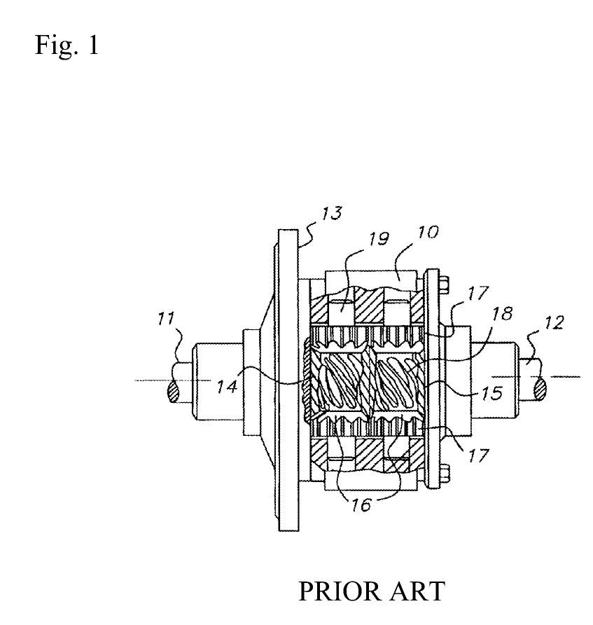

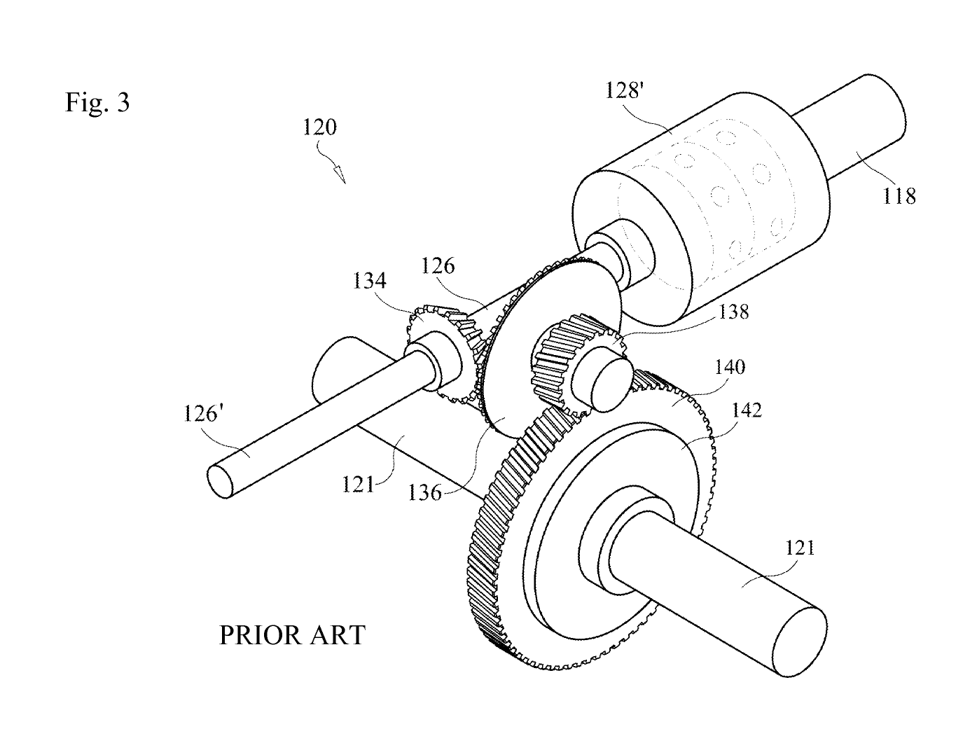

FIG. 3 is a schematic perspective view of a prior art differential complex 120 as modified when used in combination with the differential complex 120′ (identified only in FIG. 1) in the large tandem drive wheel truck 110′. Driving torque received from the drive shaft 118 is delivered to the torque-divider 128′ (indicated schematically as a cam-and-pawl mechanism). The driving torque is differentially divided in a manner well known in the art between concentric output axles, namely, a first divided-drive shaft 126 (a hollow shaft) and a second divided-drive shaft 126′ (a solid shaft). The first divided-drive shaft 126 is fixed to a bevel pinion 134 that drives a bevel ring gear 136 that, in turn, is fixed to a helical pinion 138 that drives a helical ring/bull gear 140 fixed to the housing of a conventional drive-axle differential 142. As is well understood in the art, the rotation of the housing of the drive-axle differential 142 by the ring/bull gear 140 provides the input that differentially drives the drive axles 121.

The just-described portion of the differential complex 120 that interconnects the bull gear 140 with the drive shaft 118 is referred to collectively herein as an “intermediate gear train” having differentially-divided input provided by a drive shaft.

The second divided-drive shaft 126′ delivers the differentiated drive to a differential complex 120′ that, while not shown separately in detail, is substantially identical to the just-described differential complex 120 except that it omits a torque-divider 128′. That is, as illustrated in FIG. 2, the divided-drive shaft 126′ is fixed to a similar intermediate gear train including a bevel gear pair that drives a helical gear pair with a ring/bull gear fixed to the housing of a similar conventional drive-axle differential for the drive axles 121′.

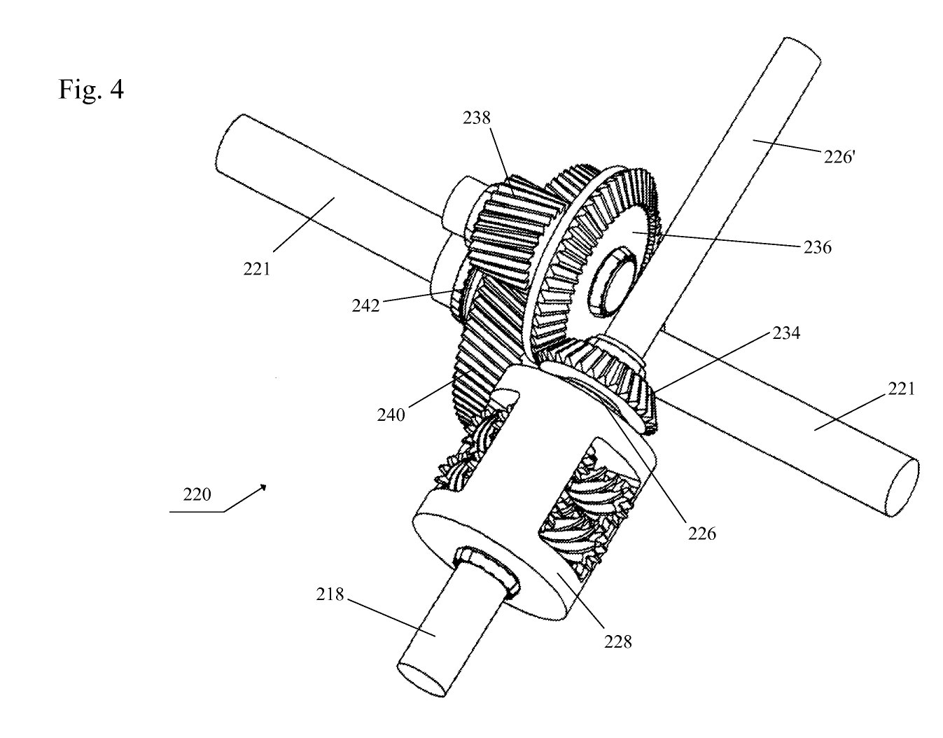

FIG. 4 illustrates the differential complex 220 of a first preferred embodiment of the invention for the drive line of a tandem drive-axle truck. As just explained above and illustrated in FIG. 3, prior art truck tandem axle drive lines are known to include a torque-divider 128′. However, as can be seen in FIG. 4, this first embodiment of the invention modifies the prior art by replacing the conventional torque-divider with a traction-assisting drive-shaft differential 228 to divide the input torque between the tandem axles of large trucks. [NOTE: The perspective of FIG. 4 is reversed relative to the perspective of FIG. 3. Namely, the position of the input drive shaft 218 in FIG. 4 is now viewed from the opposite direction of the view of the corresponding input drive shaft 118 as shown in FIG. 3.] The traction-assisting drive-shaft differential 228 is similarly positioned at the input end of the intermediate gear train. All of the other elements shown in FIG. 4 are substantially the same as in the prior art shown in FIG. 3 and just discussed above, the similar elements shown in FIG. 4 being identified by similar reference numerals in a higher numerical series. Namely, a hollow divided-drive shaft 226 connects one-half of the differentiated output of the drive-shaft differential 228 to a similar intermediate gear train that drives the first drive axles 221 and includes a bevel gear pair 234, 236 that drives a helical gear pair including a pinion 238 and a ring/bull gear 240 that is fixed to the housing of a similar conventional drive-axle differential 242 for the drive axles 221. A solid shaft divided-drive shaft 226′ connects the other half of the differentiated output of the drive-shaft differential 228 to a second differential complex for the second drive axle that, although not shown in FIG. 4, is similar to the assembly just described in the preceding sentence. Again, as explained above, the second differential complex for the second drive axle is identified with the reference numeral 120′ and is shown only schematically in FIG. 2, since it is virtually identical with the apparatus detailed in FIG. 3 but omitting the torque-divider 128′.

As indicated above, the drive-shaft differential 228 is a recently improved full-traction crossed-axis compound planetary gear differential preferably having the IsoTorque design characteristics described in the above Description of Related Art (and more fully disclosed in the above-identified documents incorporated by reference). In actual practice, this type of prior art differential does a remarkable job of preventing undesirable wheel slip under most conditions. In fact, one or more of these traction-assisting differentials are either standard or optional on vehicles presently being sold by at least eight major automobile companies throughout the world, and there are two of these differentials in every U.S. Army HMMWV (“Hummer”) vehicle (one differentiating between the front wheels and the other between the rear wheels).

All prior art crossed-axis differentials are presently referred to as “limited-slip”, and almost all of those that are presently being manufactured and sold are designed with relatively low torque bias ratios, no greater than 5-to-1. However, while the recently improved differentials described in the incorporated references can be designed with torque bias in that same range, they are preferably designed for torque bias ratios greater than 5-to-1. Therefore, these recently improved differentials are often described as being “full-traction” to distinguish their higher bias from other prior art crossed-axis differentials. Further, these improved differentials are significantly more compact, being smaller in both size and weight, and they avoid thrust duplication between the side-gear worms. They are also less costly to manufacture than earlier designs of other prior art crossed-axis differentials, while still fully meeting similar load-carrying specifications.

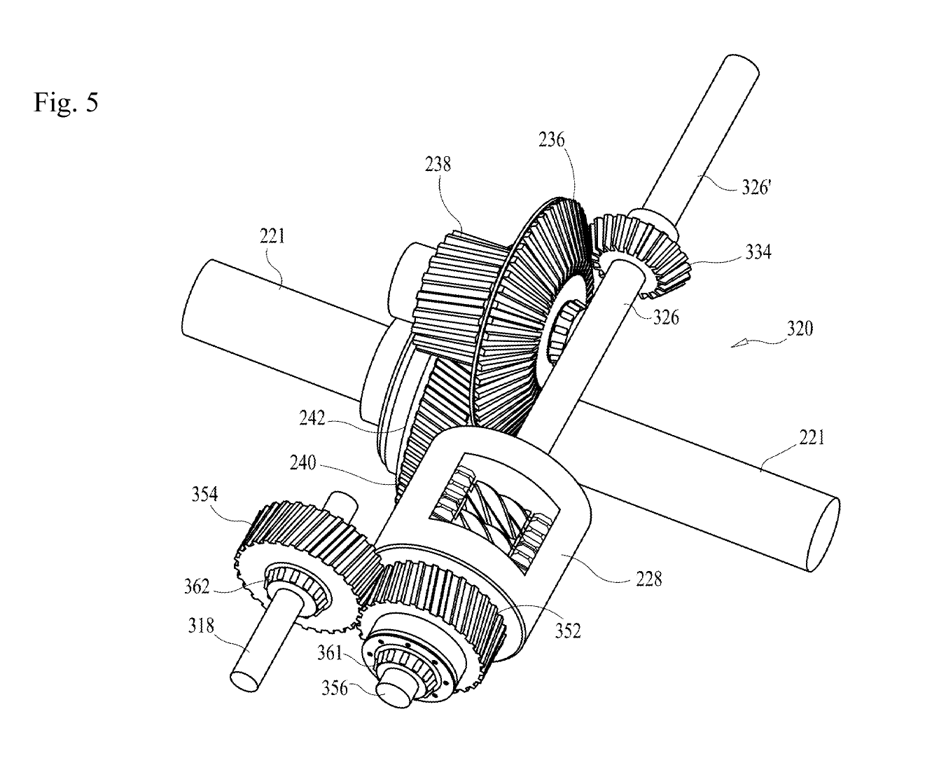

With regard to the drive-shaft differential 228 illustrated in FIGS. 4 and 5, respectively, full-traction differentials with IsoTorque design characteristics have undergone extensive use in racing vehicles, showing no significant wear after two years of racing competition. Therefore, these same differentials, appropriately sized for large truck use, are preferred to provide satisfactory performance under the loads expected for the drive-shaft differential 228.

### Drive-Ratio Quick-Change Apparatus

FIG. 5 illustrates a differential complex 320 similar to the complex 220 shown in FIG. 4 but modified further in a second embodiment of the invention to include apparatus for readily altering the drive ratio of the drive train. In the embodiment illustrated in FIG. 5, the position of the differential complex 320 relative to the vehicle drive shaft 318 has been modified slightly to receive the invention's drive-ratio change apparatus. The distal end of the drive shaft 318 has been detached from, and moved out of alignment with, the drive-shaft differential 228 which is positioned at the input to the intermediate gear train of the gear complex 320.

It is assumed that a particular changeable drive-ratio gear pair 352, 354 has been selected having a predetermined gear-ratio that is appropriate to alter the drive ratio of the illustrated drive train to accommodate an expected operating condition. (As indicated above, the invention contemplates that the truck dealer or truck fleet owner maintains a stock of changeable mating pairs having various predetermined gear-ratios and has selected an appropriate predetermined gear-ratio for the gear pair 352, 354.)

The selected changeable mating helical gears 352, 354 are joined to the drive train of the differential complex 320 by releasable connections that are only indicated schematically in FIG. 5 by the collars 361, 362. (It will be appreciated by those skilled in the mechanical arts that these releasable connections can be accomplished with any number of known combinations of various elements, e.g., screw threads and/or splines on shafts, butts, studs, bolts, and collars, rings, washers, bearings, lock nuts, etc.) In FIG. 5, the first helical gear 352 is releasably connected to a butt shaft 356 that is fixed to the housing of the differential 228, while the second helical gear 354 is releasably connected to the distal end of the drive shaft 318.

In regard to this second embodiment including the invention's quick-change apparatus shown in FIG. 5, the addition of ratio-change gears 352, 354 results in a reversal of the rotation of the housing of the drive shaft differential 228. This reversal is compensated by the extension of the hollow divided-drive shaft 326 over the solid shaft divided-drive shaft 326′ and the positioning of the bevel pinion 334 at the opposite side of the ring gear 236.

When equipped with the inventive drive just described above, the versatility of prior art truck 110′ (FIG. 2) is significantly enhanced, since its drive ratio can be readily altered to meet changing operating conditions. Should its highest drive ratio be too high for a different type of operation, e.g., more regular long distance highway use, or should its lowest drive ratio be too low for a desired change in regular operation to heavier and/or off road use, the selection of a more appropriate lower or higher ratio pair of changeable gears 352, 354 can be accomplished in about 15 minutes, rather than switching to using a different truck with the desired drive ratios.

The invention has just been described in a drive train for use in a larger prior art tandem drive axle truck 110′ (FIG. 2). However, persons skilled in the art will appreciate that the drive-ratio change apparatus of the invention may, even more simply, be applied to a drive train for use in a single drive-axle truck 110. As shown in FIG. 2 and as can be understood from the explanation above, the differential complex 120 is virtually identical with the apparatus detailed in FIG. 3 but omitting a torque-divider 128′ and its respective output drive shafts 126, 126′. In effect, the drive shaft 118 is directly fixed to the bevel pinion 134 at the input end of the intermediate gear train of the ring/bull gear 140 of the drive-axle differential 142 for dividing torque to the axles 121 and the drive wheels 122.

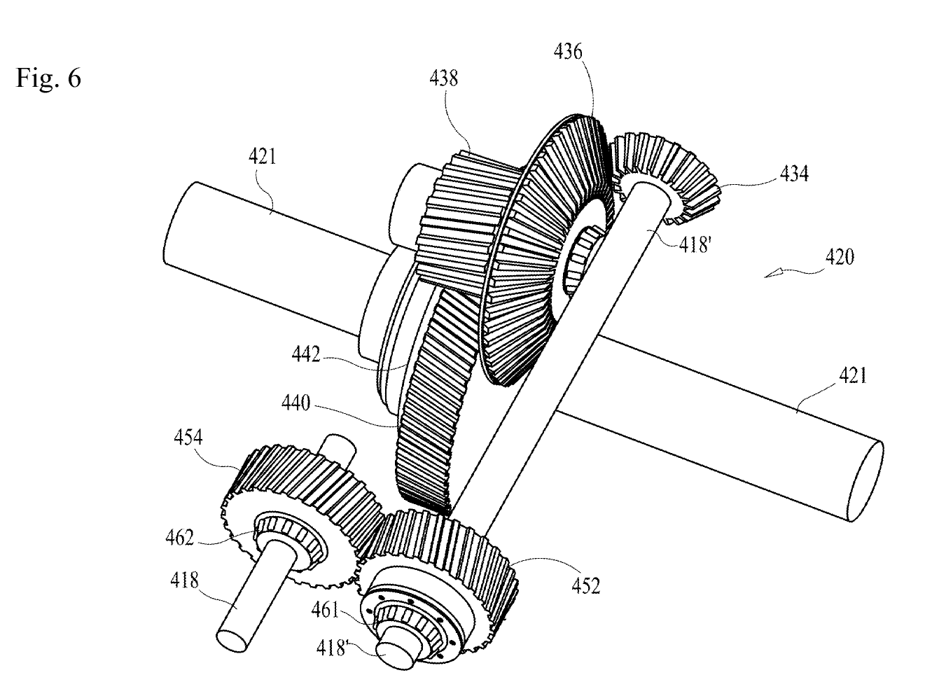

FIG. 6 shows a third embodiment of the invention similar to that just described in FIG. 5 above but modified for use in a single drive-axle truck 110 by omitting the drive-shaft differential 228 and its output drive-shafts 226, 226′. The various elements shown in FIG. 6 are similar to those shown in FIG. 5 above and are identified by similar reference numerals in a higher numerical series. Namely, a shaft 418′ connects to a similar intermediate gear train that drives the first drive axles 421 and includes a bevel gear pair 434, 436 that drives a helical gear pair including a pinion 438 and a ring/bull gear 440 that is fixed to the housing of a conventional drive-axle differential 442 for the drive axles 421. In this single drive-axle version of the invention, the changeable gear 452 is fixed to the input end of the shaft 418′ that connects with the bevel pinion 434 and the remaining portions of the intermediate gear train connected to the ring/bull gear 440 of the differential complex 420, while the changeable gear 454 remains fixed to the distal end of the vehicle drive shaft 418.

The selected changeable mating helical gears 452, 454 are joined to the drive train of the differential complex 420 by releasable connections that are only indicated schematically in FIG. 6 by the collars 461, 462. (It will be appreciated by those skilled in the mechanical arts that these releasable connections can be accomplished with any number of known combinations of various elements, e.g., screw threads and/or splines on shafts, butts, studs, bolts, and collars, rings, washers, bearings, lock nuts, etc.) In FIG. 6, the first helical gear 452 is releasably connected to the shaft 418′, while the second helical gear 454 is releasably connected to the distal end of the drive shaft 418.

In regard to this third embodiment including the invention's quick-change apparatus shown in FIG. 6, the addition of the ratio-change gears 452, 454 results in a reversal of the rotation of the housing of the shaft 418′. This reversal is compensated by the positioning of the bevel pinion 434 at the opposite side of the ring gear 436, as in the embodiment of FIG. 5.

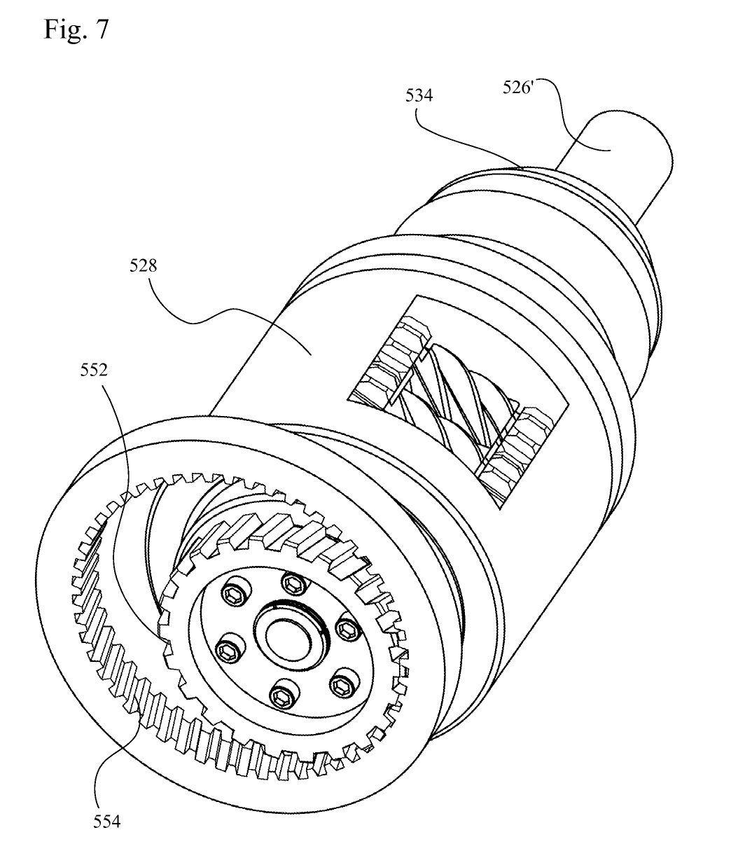

Preferred embodiments of the invention's quick-change assembly are illustrated in FIGS. 7 through 10. In these preferred embodiments, the changeable gearing includes a combination of a helical pinion within a ring gear having internal helical teeth. This alteration provides two further important advantages: (a) it allows both the pinion and ring gear to rotate in the same direction, thereby requiring no modification in the intermediate gear trains connected to the ring//bull gears of the drive axles, and (b) it simplifies alignment between the drive shaft from the vehicle transmission and the input of the differential complex assemblies of the drive axles, allowing such alignment to be made within a substantial circle of adjustability without requiring the use of universal joints.

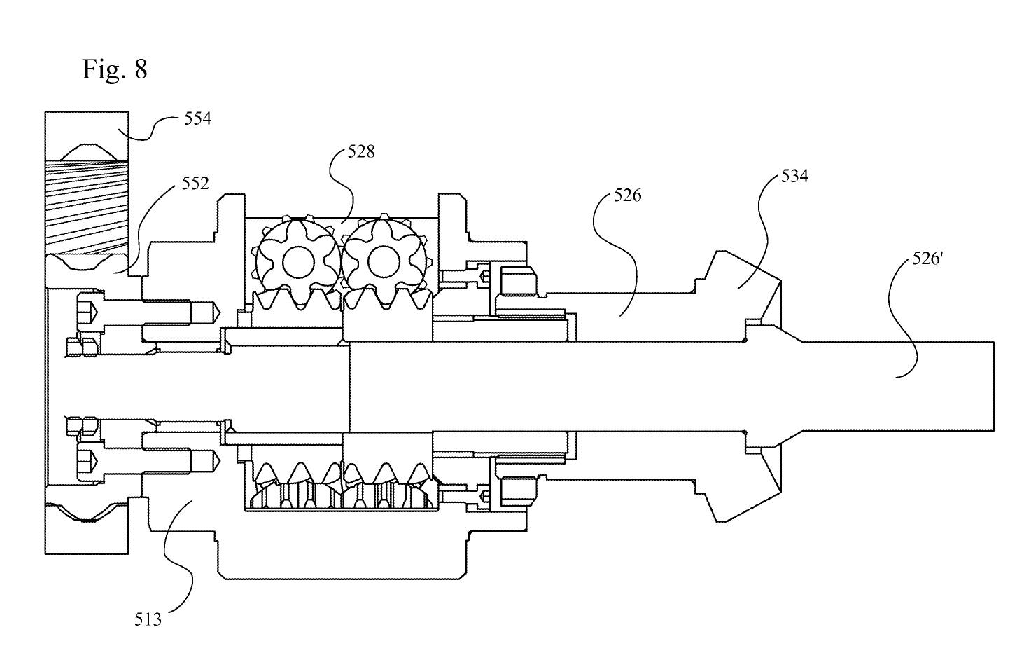

FIGS. 7 and 8 are respective perspective and cross-sectional views of a tandem drive-axle of the invention similar to that shown in FIG. 5 and explained above. However, in this fourth embodiment, a changeable helical pinion 552 is paired with a mating changeable internal ring gear 554. The helical pinion 552 is mounted on the flange 513 of the drive shaft differential 528 as shown in FIG. 8. FIG. 8 also shows the relationship between the hollow divided-drive shaft 526 and the solid shaft divided-drive shaft 526′. In terms of the transfer of driving torque, the effect of this new gear pair is exactly as that described above in regard to the changeable gears 352, 354 in FIG. 5 with a single exception: since both changeable gears 552 and 554 rotate in the same direction, the bevel pinion 534 is no longer in the position of the bevel pinion 334 as shown in FIG. 5 but rather is returned to the position of the bevel pinion 234 as shown in FIG. 4.

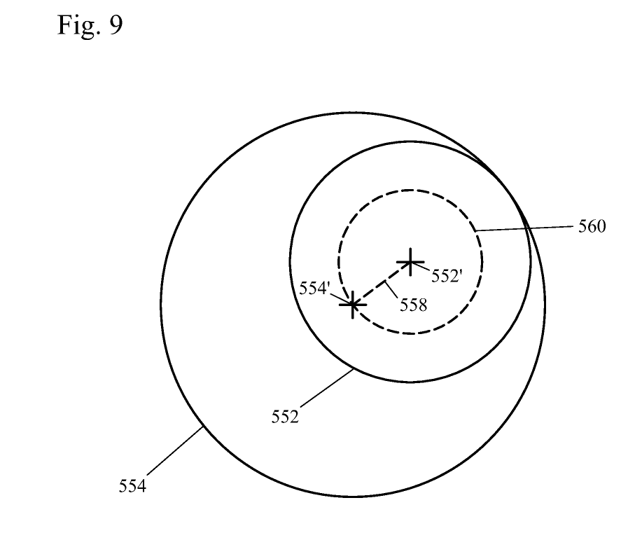

As just indicated above, the use of an internal ring gear as part of the changeable gear pair provides the additional advantage of a greater adjustability of the drive train alignment when used to alter the drive ratios of existing vehicles. Referring to FIG. 9, the changeable pinion 552 and internal ring gear 554 are illustrated schematically as a pair of circles having respective centers 552′ and 554′. Geometrically, if it is assumed that the center 552′ is fixed in space, then the changeable ring gear 554 remains in proper meshing relationship with the changeable pinion 552 so long as the distance between the centers 552′ and 554′ remains constant. In FIG. 9, the distance between the gear centers is identified by the reference numeral 558 and proper meshing of the changeable gears 552 and 554 occurs so long as the center 554′ is positioned anywhere along a circle of adjustability 560 having a radius 558.

In existing trucks, the center of the transmission drive shaft and the center of the input for the existing differential complex of the drive axle for the truck are both fixed in space. The distance between these two centers often varies from truck to truck. Therefore, for any given changeable gear pair 552, 554, these center distances can vary any where within circle of adjustability 560 and rotary connection between the transmission and drive axle can be accomplished without the necessity of a normally required universal joint apparatus.

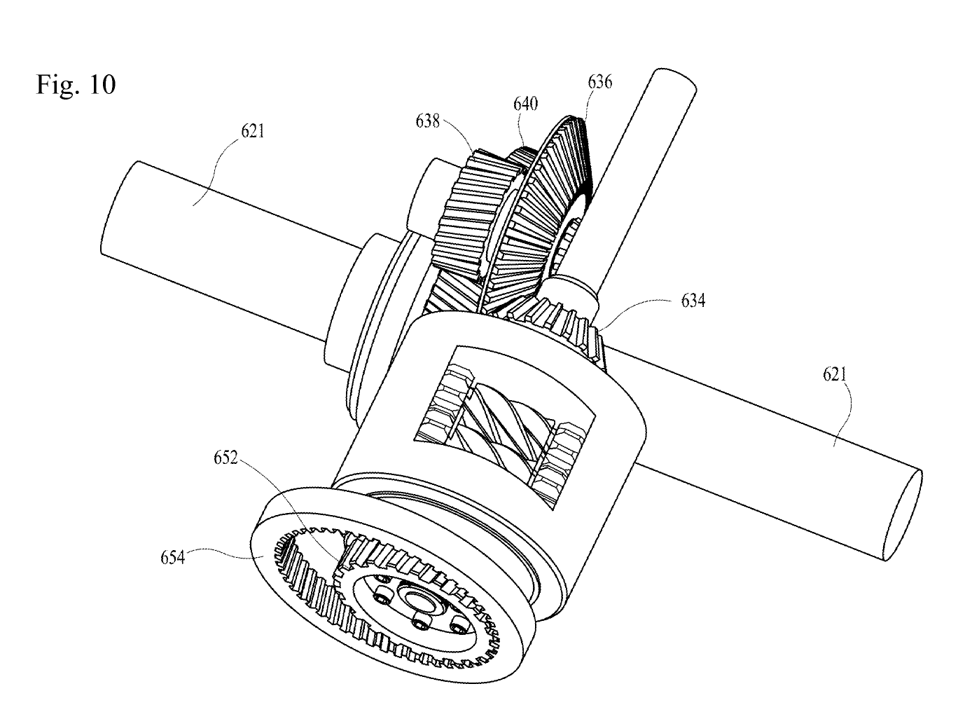

FIG. 10 is a view similar to FIG. 6, again showing a fifth embodiment of the invention applied to the input of the differential complex for a mid-size truck having only a single set of drive wheels. However, in this embodiment the readily changeable pair of drive-ratio change gears includes a helical pinion 652 and an internal ring gear 654. Again, in terms of the transfer of driving torque, the effect of this new gear pair is exactly as that described above in regard to the changeable gears 452, 454 in FIG. 6. with, again, a single exception: since both changeable gears 652 and 654 rotate in the same direction, the bevel pinion 634 is no longer in the position of the bevel pinion 434 as shown in FIG. 6 but rather is returned to the position of the bevel pinion 234 as shown in FIG. 4.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A drive-ratio change apparatus for a drive train of an automotive truck including an engine, a transmission driven by the engine, and a first set of drive wheels that are rotated at varying drive ratios of the speed of the engine in accordance with varying settings of the transmission, the drive ratios varying throughout a range beginning at a lowest drive ratio, the drive wheels being driven by a drive-wheel complex comprising a first pair of drive axles divided by a first drive-wheel differential rotated by a first ring/bull gear that is connected through a first intermediate gear train that receives an input from an output shaft of the transmission, the drive-ratio change apparatus comprising:
a first releasable connection at a distal end of an output shaft of the transmission;
a second releasable connection at an input end of the first intermediate gear train connected to the first ring/bull gear associated with the first set of drive axles; and
a single pair of changeable mating gears comprising a first mating gear having gear teeth and a second mating gear having gear teeth and positioned between the first intermediate gear train and the output shaft of the transmission, the first mating gear being releasably connected to the input end of the first intermediate gear train, and the second mating gear being releasably connected to the distal end of the output shaft of the transmission, a gear ratio of the gear teeth of the first mating gear and the second mating gear being selected to result in a predetermined value for the lowest drive ratio.

2. The drive-ratio change apparatus of claim 1, wherein the gear ratio of the single pair of changeable mating gears is selected from a predetermined group of gear ratios in accordance with the predetermined value for the lowest drive ratio for the drive train for predetermined operating conditions.

3. The drive-ratio change apparatus of claim 1, wherein the drive train of the truck further comprises:
a second set of drive wheels fixed respectively to a second pair of drive axles connected through a second drive-wheel differential rotated by a second ring/bull gear connected through a second intermediate gear train; and
a drive-shaft differential having co-axial output shafts for dividing the output from the transmission between the respective input ends of the first and second intermediate gear trains; and
wherein the input end of the first intermediate gear train is an input of the drive-shaft differential such that the second releasable connection is fixed to an input of the drive-shaft differential.

4. The drive-ratio change apparatus of claim 3, wherein the drive-shaft differential comprises a crossed-axis compound planetary gear complex.

5. A method of selectively altering the lowest drive ratio of a drive train of an automotive truck including an engine, a transmission driven by the engine, and a first set of drive wheels that are rotated at varying drive ratios of the speed of the engine in accordance with varying settings of the transmission, the drive ratios varying throughout a range beginning at a lowest drive ratio, the drive wheels being driven by a drive-wheel complex comprising a first pair of drive axles divided by a first drive-wheel differential rotated by a first ring/bull gear that is connected through a first intermediate gear train that receives an input from the output shaft of the transmission, the method comprising the steps of:
a) separating the drive train between the output shaft of the transmission and the first intermediate gear train;
b) forming a first releasable connection at the distal end of the output shaft of the transmission;
c) forming a second releasable connection at the input end of the first intermediate gear train;
d) selecting a pair of changeable mating gears from a predetermined group of changeable mating gear pairs in accordance with a predetermined value for the lowest drive ratio of the drive train for predetermined operating conditions; and
e) connecting the respective gears of the selected changeable mating gear pair to the respective releasable connections.

6. The method of claim 5, wherein the automotive truck further includes a second set of drive wheels fixed respectively to a second pair of drive axles connected through a second drive-wheel differential rotated by a second ring/bull gear connected through a second intermediate gear train and a torque-divider mechanism for dividing the output from the transmission, the method further comprising the steps of:
modifying the input end of the first intermediate gear train by replacing the torque-divider mechanism with a drive-shaft differential having co-axial output shafts for dividing the output from the transmission between the first and second intermediate gear trains; and
fixing the second releasable connection to the input of the drive-shaft differential.

7. The method of claim 6, wherein the drive-shaft differential comprises a crossed-axis compound planetary gear complex.

8. A drive train for of an automotive truck comprising:
an engine;
a transmission driven by the engine;
a first set of drive wheels that are rotated at varying drive ratios of the speed of the engine in accordance with varying settings of the transmission, the drive ratios varying throughout a range beginning at a lowest drive ratio, the drive wheels being driven by a drive-wheel complex comprising a first pair of drive axles divided by a first drive-wheel differential rotated by a first ring/bull gear that is connected through a first intermediate gear train that receives an input from the output shaft of the transmission;
first and second releasable connections positioned, respectively, at the distal end of the output shaft of the transmission and at the input of the intermediate gear train connected to the ring/bull gear associated with the first set of drive axles;
a single pair of changeable mating gears comprising a first mating gear having gear teeth and a second mating gear having gear teeth and positioned between the first intermediate gear train and the output shaft of the transmission, the first mating gear being releasably connected to the input end of the first intermediate gear train, and the second mating gear being releasably connected to the distal end of the output shaft of the transmission, a gear ratio of the gear teeth of the first mating gear and the second mating gear being selected to result in a predetermined value for the lowest drive ratio.

9. The drive train of claim 8 further comprising:
a second set of drive wheels fixed respectively to a second pair of drive axles connected through a second drive-wheel differential rotated by a second ring/bull gear connected through a second intermediate gear train; and
a drive-shaft differential having co-axial output shafts for dividing the output from the transmission between the respective input ends of the first and second intermediate gear trains; and
wherein the input end of the first intermediate gear train is an input of the drive-shaft differential such that the second releasable connection is fixed to the input of the drive-shaft differential.

10. The drive train of claim 9, wherein the drive-shaft differential comprises a crossed-axis compound planetary gear complex.
